(19) United States
(12) Patent Application Publication
(10) Pub. No.: US 2023/0214944 A1
(43) Pub. Date: Jul. 6, 2023

(54) METHOD OF CONTROLLING AND MANAGING A PRODUCTION CYCLE OF A LIVESTOCK FARM

(71) Applicant: Evonik Operations GmbH, Essen (DE)

(72) Inventors: Kshitij GUPTA, Kriftel (DE); Elmar ROTHER, Darmstadt (DE)

(73) Assignee: Evonik Operations GmbH, Essen (DE)

(21) Appl. No.: 17/999,661

(22) PCT Filed: May 11, 2021
(86) PCT No.: PCT/EP2021/062387

§ 371 Date: Nov. 22, 2022

(30) Foreign Application Priority Data
May 26, 2020 (EP) 20176536.9

(51) Int. Cl. G06Q 50/02; A01K 29/00; G06Q 10/0631

(52) U.S. Cl. CPC G06Q 50/02; A01K 29/005; G06Q 10/0631

(57) ABSTRACT

A computer-implemented method of systematically controlling and managing a production cycle of a livestock farm housing a population of animals, the method comprising (a) obtaining real-time data by a plurality of, sensors and/or manual or machine-based measurement and evaluation devices, including a set of farm condition parameters, (b) establishing statistical correlations of animal status parameters and process parameters with the animal performance parameters; (c) calculating and automatically adjusting, depending on the farm condition parameters obtained in (a) and on the statistical correlations identified in (b), a set of data set points for farm operating parameters such that at least one of a selected one of the animal performance parameters is optimized; and (d) repeatedly conducting (a) to (c) until finishing the production cycle. A system for systematically controlling and managing a production cycle of a livestock farm housing a population of animals.

### FIELD OF THE INVENTION

The present invention relates to a computer-implemented method and a system of controlling and managing a production cycle of a livestock farm housing a population of animals as e.g. chicken or other poultry.

### BACKGROUND OF THE INVENTION

Farmers have typically managed and operated farmhouses, such as chicken houses by performing the day to day farm tasks manually. These tasks primarily included providing adequate feed and water to the housed animals or livestock. Over time, it has been found that controlling certain parameters could lead to higher yields and quality in the livestock. For example, temperature, humidity, ventilation, feed cycles and lighting all contribute to successful livestock and improved yields. Moreover, through the selective breeding process, certain desired characteristics like meat yield have been modified.

Control systems for farmhouses initially started with simple analog controls, such as thermostats to control temperature in the farmhouse. Digital controllers soon followed and have generally replaced manual or analog controls in farmhouses. The relevant parameters are generally controlled automatically, via various sensors and actuators positioned throughout the farmhouse. The parameters controlled in a farmhouse, such as a poultry or hog house, generally include temperature, humidity, water, ventilation, timers for feeder and waterers, and timers for illumination.

From US 2005/0010333 a system for monitoring, managing, and/or operating a plurality of farmhouses on a plurality of farms is known including a controller and/or a monitor box in the farmhouse and a computer in communication with the controller for controlling and adjusting various parameters of the farmhouse or with the monitor box for monitoring the farmhouse. The system also includes a computer at an integrator’s office that is operable to monitor and/or control various parameters from the farmhouse remotely. These parameters enable the integrator to coordinate operations with processing plants, feed mills, field service and hatcheries. It also enables the integrator to prepare various data reports for use by the integrator or others. The integrator may standardize or determine optimal control parameters of various farms to achieve the best results as measured by the result parameters. The integrator may compare a feed rate of a first farmhouse and a second farmhouse and then compare the rate which the livestock reach a selected livestock weight. If one farmhouse achieves the selected result parameter faster, the integrator is able to determine a better control parameter to achieve the selected result parameter.

On a livestock farm today a lot of (sensor) data can thus be collected, such as temperature, air pressure, air flow, noises, CO₂, ammonia, water and feed intake, humidity, composition of the air.

This large number of measurement data is very difficult for a farmer to consider in its entirety. The adjustment of farm operating parameters as reactions to sensor data changes can therefore not be carried out in the way that would theoretically be possible due to the complexity of the data. In addition, a certain change of (sensor) data does not only suggest a certain adjustment of particular farm operating parameters but rather several different adjustments are possible.

It is therefore an object of the present invention to provide a computer-implemented method and a system of controlling and managing a production cycle of a livestock farm housing a population of animals as e.g. chicken or other poultry, which enables an improved use of the data collected at the farm in order to optimize the farming results.

### SUMMARY OF THE INVENTION

The present invention pertains to a computer-implemented method of systematically controlling and managing a production cycle of a livestock farm housing a population of animals, the method comprising the steps of
(a) obtaining real-time data by means of one or more, preferably a plurality of, sensors and/or manual or machine-based measurement and evaluation devices, the real-time data including at least the following farm condition parameters
   (a1) animal status parameters indicative of the animal status,
   (a2) process parameters descriptive of the production process; and
   (a3) animal performance parameters indicative of the performance of the animals;
(b) establishing statistical correlations of animal status parameters and process parameters with the animal performance parameters;
(c) calculating and automatically adjusting, depending on the farm condition parameters obtained in step (a) and on the statistical correlations identified in step (b), a set of data set points for farm operating parameters such that at least a selected one of the animal performance parameters is optimized;
the adjusting step being performed using at least one controller and/or at least one actuator; and
(d) repeatedly conducting process steps (a) to (c) until finishing the production cycle.

The farm condition parameters (a1) to (a3) and the farm operating parameters are as defined in the description below. In general, farm condition parameters are those parameters obtained or measured during the production cycle; whereas the farm operating parameters are those parameters that may be actively adapted or adjusted during the production cycle.

Further, the present invention provides a system for systematically controlling and managing a production cycle of a livestock farm housing a population of animals, the system comprising
(a) one or more, preferably a plurality of, sensors and/or manual or machine-based measurement and evaluation devices adapted to obtain at least the following farm condition parameters
   (a1) animal status parameters indicative of the animal status,
   (a2) process parameters descriptive of the production process; and
   (a3) animal performance parameters indicative of the performance of the animals;
(b) a first computing unit configured to establish statistical correlations of animal status parameters and process parameters with the animal performance parameters;
(c) a second computing unit configured to calculate, depending on the farm condition parameters obtained by the sensors and/or measurement and evaluation devices (a) and on the statistical correlations identified by the first computing unit (b), a set of data set points for farm operating parameters such that at least a selected one of the animal performance parameters is optimized; and
(d) a control unit adapted to automatically adjust the set of data set points for farm operating parameters as calculated by the second computing unit.

### DETAILED DESCRIPTION OF THE INVENTION

A livestock production cycle is the period during which the animals in the respective process remain in the production process, from the beginning of the process through the output of a finished product. A production cycle can, for example, be selective breeding, hatching / raising, or fattening. The process of the present invention is particularly suitable for livestock (such as poultry) fattening processes, with the young animals (e.g. hatchlings) as the starting material and the fattened animals (broilers) ready for slaughter (“finishers”) as the outputted animal product.

In the context of the present invention, the term “systematically (controlling and managing)” is to be understood as taking at least the initial controlling and management measures according to a fixed plan. Said plan, however, may be continuously systematically adapted based on the learnings from an underlying algorithm. The term “controlling” is to be understood as exercising direction over ongoing processes, and the term “managing” is to be understood as making adjustments to the process or as intervening into the process in order to optimize the process results (i.e. the animal performance parameters).

In the context of the present invention, the term “business animal performance parameters”/ “business APPs” refers to business requirements or key performance indicators of the animals (e.g. weight, uniformity etc.) that have to be met or optimized in each production cycle.

### Animal Status Parameters (A1)

The term “parameters indicative of the animal status” (animal status parameters) refers to parameters that show the actual status or condition of the animals. These parameters include the physical condition and characteristics of the animals (e.g. weight, pre-set characteristics like genetics), but also the behavior /activity of the animals (e.g. movement profiles) and parameters that allow indirect conclusions to be drawn about the health or well-being of the animals (e.g. amount of food consumed, air composition).

Advantageously, the animal status parameters (a1) include at least one parameter selected from the group consisting of distribution and movement of animals within the farmhouse, motoric activity, current weight of animals, feed consumption, the composition of the animal house’s atmosphere; or any combination of those parameters. The composition of the animal house’s atmosphere refers to the air the animals within the farmhouse inhale. Especially the ammonia, carbon dioxide and oxygen concentrations are relevant in practice. In case of direct house heating additionally oxidation products from burning fuels are present in the house atmosphere (like CO, NOx). This is of special importance during cold season when ventilation is reduced in order to save energy cost. Elevated levels of carbon dioxide for example affect activity, healthy muscle growth- thus impedes on animal health and welfare.

Further animal status parameters are e.g. gender, health parameters (e.g. diseases, antibodies, foodpad lesions, number of certain bacteria, blood profiles) and behavioral parameters (e.g. flock/herd distribution, feed and water uptake, single animal/bird and flock activity and movement as a function of time).

In a preferred embodiment of the present invention, the animal status parameters (a1) further include initial animal and environmental parameters not obtainable via sensors and/or measurement and evaluation devices, such as animal genetics and the corresponding recommended feeding regime.

### Process Parameters (A2)

The term “parameters descriptive of the production process” (process parameters) refers to parameters that are measured or monitored during the process but are not directly related to the animals. Accordingly, those parameters reflect the environmental conditions of the animals (e.g. temperature, pressure) and their supplies (e.g. water, feed, air). In addition, the process parameters also serve as direct control (verification) of the farm operating parameters.

Advantageously, the process parameters (a2) include at least one parameter selected from the group consisting of environmental parameters, quantity, quality, physical parameters, composition and metabolizable energy of feed, supplements, water supply, water quality, temperature, air pressure, air quality (CO₂, NH₃, dust), ventilation/air speed, lighting, sound, humidity; or any combination of those parameters. Further process parameters are e.g. husbandry parameters (e.g. density, lighting scheme, climate control scheme), time allowed to be spent inside or outside the house, litter/ground quality, enrichment material, feed silo content and levels and vaccination scheme.

In a preferred embodiment of the present invention, the process parameters (a2) further include additional parameters not obtainable via sensors and/or measurement and evaluation devices; such as standard operating procedures (SOPs). Farming SOPs have different sources: Apart from general textbook knowledge about animal husbandry, national legislations define certain requirements that need to be operationalized. Additionally, national agricultural advisory bodies publish recommendations for specific relevant areas, e.g. feed composition. Furthermore, the supplier of the breeds/genetics give recommendations derived from their trials and experiences. Recommendations in the field of animal nutrition in the sense of an SOP are e.g. provided by renowned bodies ranging from feed manufacturers and manufacturers of genotype chickens to specialist divisions/committees/networks (e.g. German Agricultural Society, National Research Council).

### Animal Performance Parameters (A3)

The term “parameters indicative of the performance of the animals” (animal performance parameters) refers to parameters that influence - or are correlated with - the target parameters like size/form uniformity, meat yield (weight increase, or weight increase per time unit), milk yield or laying performance (egg number, egg size, percentage of broken eggs).

Advantageously, the animal performance parameters (a3) include at least one parameter selected from the group consisting of animal health and mortality, caloric conversion rates, feed conversion rates, body weight gain; or any combination of those parameters. Further examples for animal performance parameters are e.g. live weight as a function of time, mortality rates, and healthy animal/bird rate (e.g. hatchability).

### Farm Performance Parameters (A4)

In addition to the above parameters (a1) to (a3), the farm condition parameters may also include parameters indicative of the performance of the farm (a4) as such. The term “parameters indicative of the performance of the farm” (farm performance parameters) includes, for example, parameters related to its ecological footprint, carbon dioxide and ammonia emission, litter quality, aerial pathogen load, ground water quality, water-based waste emission level and its pre-treatment, etc.

In this embodiment of the present invention, at least a selected one of the animal performance parameters and/or a selected one of the farm performance parameters is optimized by calculating and automatically adjusting a set of data set points for farm operating parameters, depending on the farm condition parameters obtained in step (a) and the on the statistical correlations identified in step (b).

Advantageously, the farm performance parameters (a4) include at least one parameter selected from the group consisting of carbon dioxide and/or ammonia emissions.

### Data Collection

The term “real-time data” as used in the context of the present invention characterizes operations that can reliably deliver certain results within a predetermined period of time, for example in a fixed time grid. Programs for processing accruing data are always ready for operation in such a way that the processing results are available within a specified period of time. Depending on the application, the data can be randomly distributed over time or be generated at predetermined points in time.

Such real-time data are obtained by means of one or more sensors and/or manual or machine-based measurement and evaluation devices. The term “sensor” refers to any device, module, machine or subsystem whose purpose is to detect data, changes or events in its environment and sends the information to other electronics, preferably a computer processor. The sensors used in the method according to the present invention may include optical, acoustical and/or chemical sensors.

The farmhouse comprises a plurality of sensors including optical, acoustical and/or chemical sensors. The thus-obtained data can include data on temperature, air pressure, ventilation, lightning, on distribution and movement of the animals within the farmhouse, motoric activity of the animals, weight of the animals, feed and water consumption, sound data, air composition data and olfactory data.

The term “measurement and evaluation devices” refers to devices that monitor or help the farmer read and confirm measurements of weight, number of animals per unit area, distribution in living space, behavior, etc., which cannot be accurately measured by a machine without human intervention, adjustment and confirmation.

Distribution, movement, and motoric activity of the animals may be determined by statistical analysis of video- or photo-based data. Animal weight may be determined using an appropriate weight meter, such as one that measures the force produced on a roosting rod of chicken roost. Feed consumption may be determined using a feeder with a fill system including a flow meter that is able to measure the amount of feed provided to the farmhouse that is consumed by the livestock contained therein. Air composition and olfactory data may, for example, be determined using electronic noses or gas chromatography (GC).

### Establishing Statistical Correlations

Statistical correlations may be empirically established or learned from the past performance parameters from the respective farm and/or from the animal performance parameters following changes in the farm operating parameters in similar past situations. This learning is based on regression analysis, back propagation, a series of feature or representation learning algorithms and association rules, which help in creating decision trees for various types of inputs for expected optimized outputs and, based on them, the development of (small) neural networks. The statistical correlations may be established using semi-reinforcement learning (or supported reinforcement learning) while trying to achieve the best balance of the selected animal performance parameters (APPs) -since all APPs can never be optimized simultaneously- and may, additionally, be supported by or matched with a library of scientifically “possible” or scientifically verifiable or verified results.

Scientific “possible” results in the context of the present invention are cross-checked or cross-validated results obtained from model systems, such as biological/physical models.

### Adjustment of Farm Operating Parameters

During the production cycle, the above-mentioned parameters (a1), (a2), (a3), and optionally (a4) are obtained and monitored in real-time, whereas the farm operating parameters are actively adjusted during the process (process step (c)).

In the context of the present invention, the term “farm operating parameters” refers to those parameters that can actively be set, managed or adjusted (in advance of or) during the process.

Examples for farm operating parameters are a defined temperature / temperature range, a defined lighting scheme or program, a defined fresh air supply, a defined draft with regard to the flow velocity or the provision of a defined amount of feed per time unit. Accordingly, “adjusting a set of data set points for farm operating parameters” can mean, for example, that the combined effect of humidity, temperature, air flow and lighting scheme, especially in the context of external weather conditions, has an impact on what can be altered to what extent in the house. Also, water and feed-based additives can be applied to counter the undesired effects or amplify the desired of other influencing parameters.

A farmhouse comprises facilities or sub-facilities to provide the animal population with defined quantities of the necessary supplies as, for example, water, feed, ventilation, temperature, humidity, feed supplements, probiotics, drugs, vaccination etc. The ventilation system (typically including fans that can be turned off and on and fan shutters that may open and close) allow for controlling the amount of fresh air intake into the farmhouse and also for pressure differentiation. The ventilation system, including its various components, may affect temperature and air quality (such as ammonia and carbon dioxide concentration and oxygen levels) within the farmhouse. Temperature may be indirectly controlled via the ventilation system. However, it may also be directly controlled by an evaporative cooling system and brooders. The evaporative cooling system can not only adjust the temperature parameter but also the humidity level within the farmhouse by drawing air through a wetted pad. Feeding and watering of the animals, preferably swine and chicken, may be controlled by (automated) feeders that are supplied by a feed bin and a fill system. All processes of these facilities or sub-facilities are directly adjusted by the aforementioned algorithms e.g. via specific actuators.

The adjustments made via the process according to the present invention depend on the farm condition parameters obtained in step (a) and on the statistical correlations identified in step (b) and are calculated preferably using at least one algorithm. The result of such calculation is then immediately executed by modifying a set of data set points for farm operating parameters. Preferably, the calculating and adjusting step (c) is performed using a machine learning procedure operating on a neural network to iteratively adjust the set of farm operating parameters dependent on the obtained animal status parameters and process parameters and wherein the animal performance parameters and measured statistical correlations between the animal status and process parameters are used as target parameters for training the neural network.

Advantageously, the calculation step is performed using a combination of algorithms that are made available via an algorithm library. The algorithm library in the sense of the present invention is an archive of algorithms correlated to the optimization of individual APPs. The algorithm library may be a simple database of best algorithms/ variants for optimizing the APPs, generally in isolation, and, if known, their impact on other APPs.

Preferably, the calculating in step (c) is performed using a prediction engine. The prediction engine in the context of the present invention is an algorithm-based system configured to extract information from data and using same for predicting trends and possible intermediate and final process results, each with a certain probability. The prediction engine according to the present invention preferably processes statistical correlations established in step (b) using algorithms form the algorithm library.

In the latter case, based on the statistical correlations established in step (b), the algorithms of the library are prioritized (or re-prioritized) for the individual animal performance parameter and the corresponding optimization calculations conducted in step (c). With every newly discovered statistical correlation, the prioritization may change and the machine then learns (machine learning). The best algorithm for a singular APP can be earmarked or labeled as such. However, the prioritized picking of the algorithms by the prediction engine takes into account simulation-based optimizations to minimize loss on other APPs, which may be considered as constraints. The rules for the prediction engine’s prioritization of the algorithms are therefore based on a genetic algorithm, which optimizes the selected (or known desired) business APPs while considering constraints.

A genetic algorithm in the context of the present invention refers to a search heuristic that reflects the process of natural selection where the fittest individuals are selected. For example, in order to reduce mortality to minimum, the machine may calculate that placing zero chickens on a broiler farm is optimal; however, this theoretical possibility can be ignored by the prediction engine if it gets a constraint of placing at least 30,000 one day-old chickens per cycle. Similarly, if the business APPs dictate a maximization of profit while upholding minimum required regulatory standards for sustainable livestock farming, the prediction engine will pick an algorithm that balances the two needs, even if it can asymptotically never reach the maximum profit. Herein, a prediction engine can be applied which gets its input for animal performance parameters and business APPs that need to be optimized, can thereby pick the prioritized algorithms and apply them on the obtained farm condition parameters. The results of the prediction engine’s calculations can optionally be compared with the possible science-based results of the animals’ response, which, as an example, can be identified on the basis of the biological model of the animals. This reduces the possible set of outcomes to only those that are scientifically possible. Such scientific validation can increase the quality and accelerate the delivery of optimum calculation results. The algorithms may need periodical fitting through supervision and manual re-prioritization to provide most promising results/adjustments to achieve the desired animal performance parameters.

Process step (c) may be performed in a phased, regular or continuous manner and is advantageously performed using at least one controller and/or at least one actuator.

In accordance with the above, the present invention also pertains to a system for systematically controlling and managing a production cycle of a livestock farm housing a population of animals, the system comprising
(a) one or more, preferably a plurality of, sensors and/or manual or machine-based measurement and evaluation devices adapted to obtain at least the following farm condition parameters
   (a1) animal status parameters indicative of the animal status,
   (a2) process parameters descriptive of the production process; and
   (a3) animal performance parameters indicative of the performance of the animals;
(b) a first computing unit configured to establish statistical correlations of animal status parameters and process parameters with the animal performance parameters;
(c) a second computing unit configured to calculate, depending on the farm condition parameters obtained by the sensors and/or measurement and evaluation devices (a) and on the statistical correlations identified by the first computing unit (b), a set of data set points for farm operating parameters such that at least a selected one of the animal performance parameters is optimized; and
(d) a control unit adapted to automatically adjust the set of data set points for farm operating parameters as calculated by the second computing unit.

Advantageously, the second computing unit is a prediction engine including a genetic algorithm configured to optimize the selected animal performance parameters while minimizing losses on the non-selected animal performance parameters. The control unit may comprise or consist of at least one controller and/or at least one actuator.

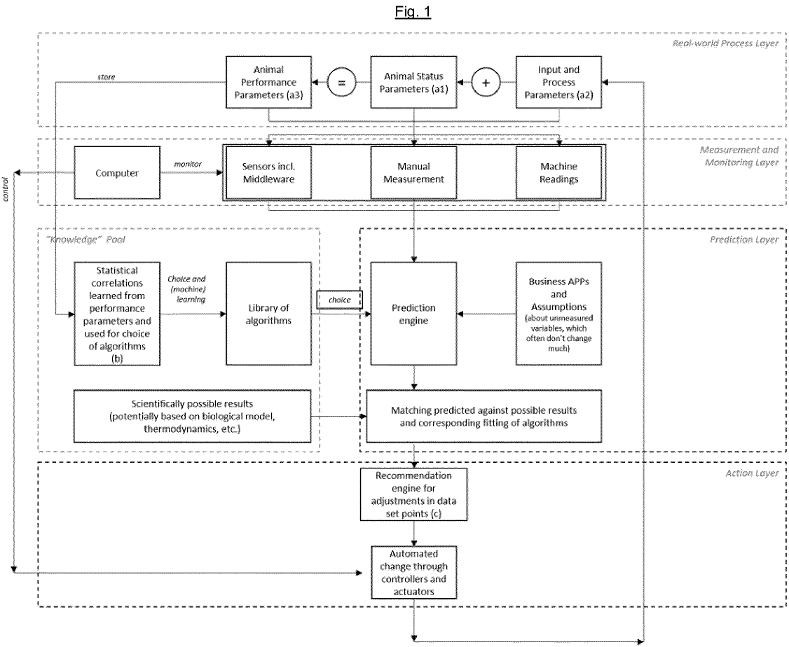

A specific embodiment of the present invention is depicted in FIG. 1. The system as a whole includes a real-world process layer, a measurement and monitoring layer, a prediction layer and an action layer. Animal status parameters (a1) and process parameters (a2) which influence the animal performance parameters (a3) are part of the real-world process layer. These parameters were obtained in the measurement and monitoring layer using sensors (incl. middleware), manual or machine-based measurement and evaluation devices or machine readings and inputted into a first computing unit configured to establish statistical correlations of animal status parameters and process parameters with the animal performance parameters. Said first computing unit may be embedded in a knowledge pool. Such knowledge pool further includes a library of algorithms as described above and optionally also means for obtaining scientifically “possible” results e.g. obtained from model systems, such as biological/physical models, as described above.

Based on the output of the first computing unit (i.e. the statistical correlations of animal status parameters and process parameters with the animal performance parameters), suitable algorithms are selected from the library of algorithms which are then applied in the second computing unit, being a prediction engine. The information processed by the prediction engine also includes business APPs, and optionally also assumptions about unmeasured variables. The output of the prediction engine is matched against scientifically possible results which then serve as input for a recommendation engine which outputs a set of data set points for farm operating parameters that are to be adjusted. Finally, those adjustments are put into practice through controllers and actuators. These process steps are repeated until the end of the production cycle.

1. A computer-implemented method of systematically controlling and managing a production cycle of a livestock farm housing a population of animals, the method comprising:
(a) obtaining real-time data by one or more sensors and/or manual or machine-based measurement and evaluation devices, the real-time data including at least the following farm condition parameters:
(a1) animal status parameters indicative of an animal status;
(a2) process parameters descriptive of a production process; and
(a3) animal performance parameters indicative of a performance of the animals;
(b) establishing statistical correlations of the animal status parameters and the process parameters with the animal performance parameters;
(c) calculating and automatically adjusting, depending on the farm condition parameters obtained in (a) and on the statistical correlations identified in (b), a set of data set points for farm operating parameters such that at least one of a selected one of the animal performance parameters is optimized; wherein:
the adjusting is performed with at least one controller and/or at least one actuator; and
(d) repeatedly conducting (a) to (c) until finishing the production cycle.

2. The method according to claim 1, wherein the animal status parameters (a1) include at least one parameter selected from the group consisting of distribution and movement of animals within the farmhouse, motoric activity, current weight of animals, feed consumption, composition of the animal house’s atmosphere, and any combination thereof.

3. The method according to claim 1, wherein the process parameters (a2) include at least one parameter selected from the group consisting of environmental parameters, quantity, quality and composition of feed, supplements, water supply, temperature, air pressure, ventilation, lighting, sound, humidity, and any combination thereof.

4. The method according to claim 1, wherein the animal performance parameters (a3) include at least one parameter selected from the group consisting of animal health and mortality, caloric conversion rates, feed conversion rates, body weight gain, and any combination thereof.

5. The method according to claim 1, wherein the animal status parameters (a1) further include initial animal and environmental parameters not obtainable via sensors and/or measurement and evaluation devices.

6. The method according to claim 1, wherein the farm condition parameters further include: (a4) parameters of the condition of the farm; wherein:
the parameters of the condition are at least one selected from the group consisting of carbon dioxide emission, ammonia emission, litter quality, aerial pathogen load, ground water quality, water-based waste emission level, and any combination thereof.

7. The method according to claim 1, wherein in (b), the statistical correlations of animal status parameters and process parameters with the animal performance parameters are empirically established frompast animal performance parameters from the farm and/or from the animal performance parameters following changes in the farm operating parameters in past situations.

8. The method according to claim 1, wherein in (b), the statistical correlations of animal status parameters and process parameters with the animal performance parameters are established with semi-reinforcement learning.

9. The method according to claim 1,
wherein the calculating and adjusting in (c) is performed with a machine learning procedure operating on a neural network to iteratively adjust the set of farm operating parameters dependent on the obtained animal status parameters and the process parameters; and
wherein the animal performance parameters and measured statistical correlations between the animal status and the process parameters are target parameters for training the neural network.

10. The method according to claim 1, wherein the calculating in (c) is performed with a combination of algorithms that are made available via an algorithm library.

11. The method according to claim 1, wherein the calculating in (c) is performed with a prediction engine including a genetic algorithm which optimizes selected animal performance parameters while minimizing losses on non-selected animal performance parameters.

12. The method according to claim 1, wherein the adjusting in (c) is performed with at least one actuator.

13. The method according to claim 1, wherein (c) is performed in a phased, regular or continuous manner.

14. A system for systematically controlling and managing a production cycle of a livestock farm housing a population of animals, the system comprising:
(a) one or more sensors and/or manual or machine-based measurement and evaluation devices adapted to obtain at least the following farm condition parameters:
(a1) animal status parameters indicative of an animal status;
(a2) process parameters descriptive of a production process; and
(a3) animal performance parameters indicative of a performance of the animals;
(b) a first computing unit configured to establish statistical correlations of the animal status parameters and the process parameters with the animal performance parameters;
(c) a second computing unit configured to calculate, depending on the farm condition parameters obtained by the sensors and/or measurement and evaluation devices in (a); and
the statistical correlations identified by the first computing unit (b), a set of data set points for farm operating parameters such that at least one of a selected one of the animal performance parameters is optimized; and
(d) a control unit adapted to automatically adjust the set of data set points for the farm operating parameters as calculated by the second computing unit.

15. The system according to claim 14, wherein the second computing unit is a prediction engine including a genetic algorithm configured to optimize selected animal performance parameters while minimizing losses on non-selected animal performance parameters.
